(19) United States
(12) Patent Application Publication
(10) Pub. No.: US 2005/0129607 A1
(43) Pub. Date: Jun. 16, 2005

(54) Method for producing fullerenes

(76) Inventors: Hiroaki Takehara, Kitakyushu-shi (JP); Tsuyoshi Takakura, Kitakyushu-shi (JP); Mineyuki Arikawa, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/735,824

(22) Filed: Dec. 16, 2003

(51) Int. Cl. C01B 31/00

(52) U.S. Cl. 423/445 B; 977/DIG. 1

(57) ABSTRACT

A hydrocarbon fuel is either imperfectly combusted or thermally decomposed in a reactor 11, thereby producing a high-temperature gas flow containing fullerenes and soot. Then, the gas flow from the reactor 11 is cooled in a range of over 600 to 900° C. by a temperature adjustment unit 12. Consequently, the cooled gas flow is introduced to a first filter, and the soot contained in the gas flow is removed. The gas flow having passed through the first filter is further cooled to collect the fullerenes as solid. In this case, a second filter is used according to need.

### BACKGROUND OF THE INVENTION

The present invention relates to a method for producing fullerenes (new carbon materials) based on the either imperfect combustion or thermal decomposition of a hydrocarbon fuel. The new carbon materials, fullerenes, are closed cage carbon molecules such as, e.g., C60, C70, C76, C78, C82, C84, C86, C88, C90, C92, C94, and C96. The fullerenes as discussed above also include higher-order fullerenes that are insoluble in a usual solvent such as toluene or xylene.

Closed cage carbon molecules, fullerenes, as discussed above have recently been discovered. The fullerenes exhibit unique solid-state properties from unusual molecular structures of the fullerenes. Studies have been made to determine the properties of the fullerenes, and to develop the use of the fullerenes. The fullerenes are expected to be applicable in fields of, e.g., diamond coating, battery materials, painting, thermal insulating materials, lubricants, pharmaceuticals, and cosmetics. Methods such as arc discharging, resistance heating, laser evaporation, and combustion are known as methods for producing the fullerenes. For example, a combustion method for imperfectly combusting cyclic aromatic hydrocarbons such as benzene and toluene is expected as a way of producing a huge amount of fullerenes at low costs.

Methods for producing the fullerenes in accordance with the combustion method are disclosed in, e.g., published U.S. Pat. No. 5,273,729 and U.S. Patent Application Publication No. US2003/0041732. According to these methods, a hydrocarbon fuel in a reactor under reduced pressure is incompletely combusted to yield the fullerenes; a filter collects a mixture containing the fullerenes and soot (hereinafter sometimes simply called “fullerene-containing soot”) that is contained in an exhaust gas from the reactor; and a solvent separates the fullerenes from the collected mixture. Since the reactor produces the exhaust gas having highly elevated temperatures as high as 1500 to 2000° C., a cooling unit at first cools down the exhaust gas to temperatures of at most 300° C. before the exhaust gas is allowed to flow through the above-described filter. In this way, the mixture containing the fullerenes and soot is collected. The collected mixture is then introduced into the solvent to separate the fullerenes soluble in the solvent from the insoluble soot (high-molecular-weight carbons), thereby separating the fullerenes dissolved in the solvent therefrom.

As taught by published Japanese Patent Application Laid-Open No. 9-227111, there has been known another method (a sublimation method) for sublimating the fullerenes by heating the fullerene-containing soot under a high vacuum of 1 to 10⁻³ torr.

However, the mass production of the fullerenes according to the above methods must cool down a large quantity of the exhaust gas in a short time. This requirement must be met by the supply of a large-scaled cooling unit and a large amount of cooling water. In order to provide a more efficiently operating cooling unit, a contact between the exhaust gas and a refrigerating portion of the cooling unit may be increased in area. However, this countermeasure brings about a problem in which smoke dust and solidified fullerenes reside on the increased contact portion, with the result that the cooling unit is likely to be clogged up therewith.

A reduction in temperature of the gas emissions from the reactor to 300° C. or less solidifies the fullerenes as well as the soot. The filter collects such a solidified mixture. However, several processes employing the solvent are required to collect only the fullerenes from the mixture. This requirement causes another problem of the need for larger-scaled equipment and time-consuming. More specifically, almost all of the fullerenes usually have a property of being soluble in an organic solvent such as benzene, but the solubility thereof with reference to the solvent is as low as less than 1% with a consequential problem that a large amount of solvent must be provided to separate the fullerenes using the solvent.

In the fullerene separation according to the sublimation method, the gas emissions at temperatures of 1500 to 2000° C. are cooled down to temperatures of at most 300° C. before the fullerene-containing soot is collected; and the collected soot is heated to an elevated temperature under a high vacuum to sublimate the fullerenes. Consequently, these steps lose a substantial amount of thermal energy.

The fullerene-containing soot collected at the temperatures of 300° C. or less sometimes contains either unburned fuel or polycyclic aromatic compounds resulting from the unburned fuel. As represented by benzopyrene, the polycyclic aromatic compound has a small proportion of hydrogen atoms in composition among aromatic compounds, and is similar to the fullerenes. As a result, when the polycyclic aromatic compounds are mixed with the fullerenes, such a mixture is likely to inhibit the reaction of the fullerenes, or to adversely affect the inherent properties of the fullerenes. In addition, some of the polycyclic aromatic compounds may be physically detrimental. Therefore, it is preferred that the polycyclic aromatic compounds are reduced in amount as few as possible. The polycyclic aromatic compound herein refers to either a monocyclic or a polycyclic aromatic compound having at least one aromatic ring. More specifically, the polycyclic aromatic compounds herein include naphthalene, anthracene, phenanthrene, and benzopyrene.

### SUMMARY OF THE INVENTION

In view of the above, an object of the present invention is to provide a method for producing fullerenes, operable to efficiently collect and separate fullerenes from a large quantity of fullerene-containing soot that is generated during the mass production of the fullerenes.

To achieve the object, the present invention provides a method for producing fullerenes, comprising: a first process of either imperfectly combusting or thermally decomposing a hydrocarbon fuel in a reactor, thereby producing a high-temperature gas flow containing the fullerenes and soot; a second process of introducing the high-temperature gas flow containing the fullerenes and soot (exhaust gas) from the reactor into a first filter including a heat-resistant filtering element, to allow the fullerenes in a gaseous state to flow through the first filter, thereby collecting the soot from the gas flow in the first filter; and a third process of lowering a temperature of the gas flow having just flowed through the first filter, in order to solidify the fullerenes, thereby collecting and separating the fullerenes from the gas flow. As described above, the first filter collects only the soot from the exhaust gas, and consequently the fullerenes free of the soot are provided. The method for producing fullerenes according to the present invention advantageously eliminates the need for a large quantity of solvent in contrast to the prior art.

The heat-resistant filtering element must be formed by any substance that withstands a temperature of 600° C. or greater. Such a substance can be, e.g., a metal mesh, a sintered alloy, and a porous ceramics. A thicker filtering element provides the increased strength of the filtering element, but results in a greater pressure loss. In light of a heat resistant filtering element characterized by a reduced pressure loss and sufficient strength, the use of, e.g., a sintered alloy-filtering element made of stainless steel is advisable. In addition, a filtering element including minute or very small gas-permeable apertures is needed because the filtering element must eliminate minute carbon soot. A preferred gas-permeable aperture ranges from 0.5 to 5 μm, and more preferably from 1 to 3 μm.

The filtered gases having just flowed through the first filter are lowered in temperature, thereby forming the gases into solids. Therefore, the solids are readily collectable.

The present invention provides a method for producing fullerenes, wherein the gas flow at an entrance of the first filter preferably have a temperature falling within a range of more than 600 to 900° C., and more preferably within a range of 700 to 800° C. As a result, the fullerenes in the gas flow are evaporated to flow through the first filter. However, gas flow having temperatures of greater than 900° C. requires the use of heat-resistant peripherals such as heat-resistant piping passages in addition to the heat-resistant filtering member. This results in higher equipment costs.

The present invention provides a method for producing fullerenes, wherein the gas flow after having passed through the first filter preferably has a temperature controlled within a range at which polycyclic aromatic compounds contained in the gas flow are held in a gaseous state, and wherein the fullerenes free of the polycyclic aromatic compounds are preferably collected using a second filter. As a result, the fullerenes free of the polycyclic aromatic compounds are readily collectable. A preferred control temperature of the gas flow ranges from, e.g., 300 to 600° C.

The present invention provides a method for producing fullerenes, wherein the gas flow after having flowed through the first filter is cooled down to a temperature of 200° C. or less, thereby collecting the solidified fullerenes from the gas flow using a second filter. In this instance, a non-heat resistant second filter is acceptable, and may be made of, e.g., a synthetic resin material. This feature realizes low cost equipment. Control over combustion conditions makes it feasible to produce a reduced amount of the polycyclic aromatic compounds mixed in the fullerenes.

The present invention provides a method for producing fullerenes, wherein the reactor is of an upright type, and is provided with a burner at a lower portion of the reactor for either imperfectly combusting or thermally decomposing the hydrocarbon fuel, and with an exhaust port at an upper portion of the reactor, through which the high-temperature gas flow containing the fullerenes and soot is discharged to the outside of the reactor. Alternatively, an inverted reactor may be employed, which has an exhaust port and a burner provided at the lower and upper portions of the reactor, respectively. As a result, the inverted reactor prevents the soot from residing on the burner.

### BRIEF DESCRIPTION OF THE DRAWINGS

FIG. 1 is a descriptive illustration showing how fullerenes are produced in accordance with an embodiment of the present invention; and

FIG. 2 is a graph illustrating how fullerene-containing soot is reduced in weight when the fullerene-containing soot is heated.

### DETAILED DESCRIPTION OF THE INVENTION

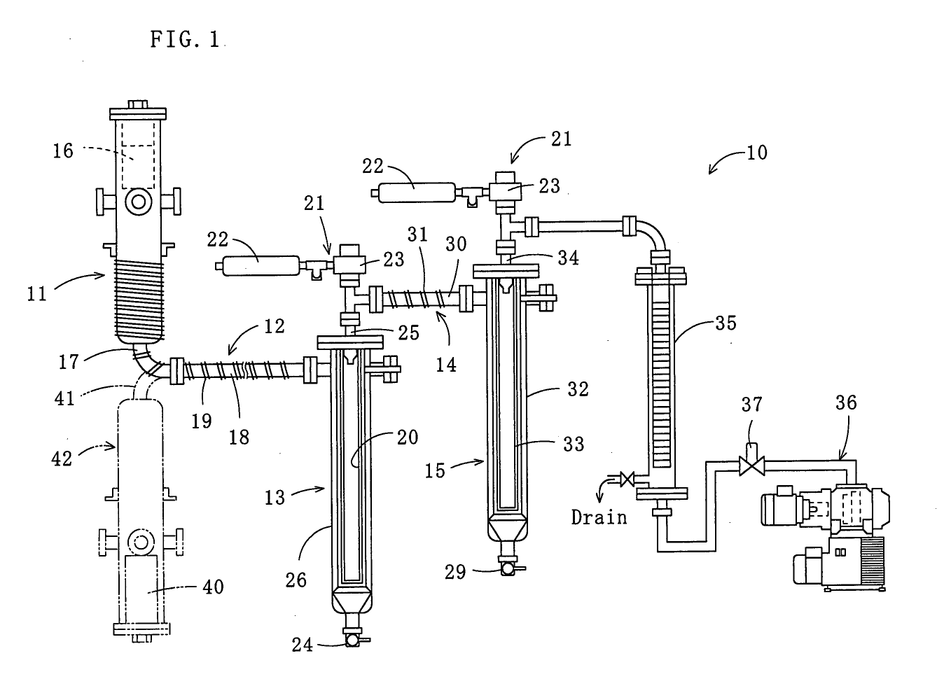

Fullerene-manufacturing equipment 10 embodying a method for producing fullerenes according to an embodiment of the present invention is now described. As illustrated in FIG. 1, the fullerene-manufacturing equipment 10 includes a reactor 11, a first temperature-regulating unit 12, a first filter 13, a second temperature-regulating unit 14, and a second filter 15. The reactor 11 is operable to produce fullerenes in accordance with a combustion method. The first temperature-regulating unit 12 is operable to regulate the temperature of a high-temperature gas flow containing the fullerenes and soot (hereinafter sometimes simply called “exhaust gas”) generated in the reactor 11 within a range of greater than 600 to 900° C. The first filter 13 is operable to separate the soot from the exhaust gas that has just flowed through the first temperature-regulating unit 12. The soot is in the form of a solid or rather powder when the exhaust gas is at the temperatures of 600 to 900° C. The second temperature-regulating unit 14 is operable to further lower the temperature of the exhaust gas that has just flowed through the first filter 13 to a range of 300 to 600° C. The second filter 15 is operable to collect the fullerenes from the exhaust gas that has just passed through the second temperature-regulating unit 14. The following discusses details of each of the above components.

Pursuant to the present embodiment, the fullerenes are produced in accordance with the combustion method. Accordingly, the reactor 11 has internal pressure depressurized with reference to atmospheric pressure, and is preferably in a nearly vacuum state (e.g., at least 20 and at most 200 torr, and more preferably in a range of 30 to 60 torr). The reactor 11 has a burner 16 and an exhaust port 17 disposed at upper and lower portions thereof, respectively. The burner 16 is operable to either incompletely burn or thermally decompose a hydrocarbon fuel. The exhaust port 17 discharges the high-temperature gas flow containing the fullerenes and soot to the outside of the reactor 11. This reactor construction is advantageous in that an ejecting port of the burner 16 is kept open without being clogged up with the soot formed in the reactor 11. The lower portion of the reactor 11 is gradually reduced in diameter toward the exhaust port 17, thereby smoothly blowing the soot out of the reactor 11 through the exhaust port 17.

The interior of the reactor 11 is lined with refractories because the internal temperature of the reactor 11 is elevated to 1500 to 2000° C. The exterior of the reactor 11 is made of water-cooled, heat-resistant steel or stainless steel. The burner 16 is supplied with an oxygen-containing fuel gas that is a mixture of an oxygen gas and a gaseous aromatic hydrocarbon fuel such as toluene or benzene (examples of the hydrocarbon fuels). In certain cases, an inert gas such as an argon gas may be added to the fuel gas. The hydrocarbon fuel and the oxygen-containing gas are mixed together in such a manner that a molar ratio of carbon to oxygen lies within a range of 0.97 to 1.36. As a result, the hydrocarbon fuel is imperfectly combusted under a reduced pressure, thereby producing the fullerenes.

Aromatic hydrocarbons having the number of carbons falling in a range of six to twenty, e.g., benzene, toluene, xylene, naphthalene, methylnaphthalene, anthracene, and phenanthrene, are preferably employed as the above-described hydrocarbon fuel. In conjunction with such aromatic hydrocarbons, aliphatic hydrocarbons such as hexane, heptane, and octane may be used as an alternative hydrocarbon fuel. As a further alternative, a hydrocarbon fuel having two or more five-membered rings, two or more six-membered rings or a mixture of one or more five-membered rings and one or more six-membered rings may be employed.

The first temperature-regulating unit 12 is disposed between the reactor 11 and the first filter 13. The first temperature-regulating unit 12 includes a piping passage 18 and a coolant pipe 19 that extends around the exterior of the piping passage 18. The piping passage 18 is made of a heat-resistant metallic material (e.g., stainless steel or heat-resistant steel). The exhaust gas containing the fullerenes and soot turbulently enters the piping passage 18 from the reactor 11 through the exhaust port 17. According to the present embodiment, the exhaust port 17 and the piping passage 18 are smoothly connected together in coaxial alignment therebetween. Alternatively, the exhaust port 17 may be connected to the piping passage 18 in a direction tangential to the outer circumference of the piping passage 18, thereby allowing the exhaust gas to flow in a swirl inside the piping passage 18. As a result, while being swirled in the piping passage 18, the exhaust gas containing the fullerenes and soot is cooled down in efficient contact with a pipe wall of the piping passage 18. The exhaust gas flowing in a swirl inside the piping passage 18 is advantageously resistant to clogging up the piping passage 18 with the soot contained in the exhaust gas.

The first temperature-regulating unit 12 cools down the exhaust gas from the reactor 11 to the temperatures within a range of, e.g., greater than 600 to 900° C. (more preferably within a range of 600 to 700° C.). The temperatures can be regulated in accordance with an adjustment in length of the piping passage 18 and adjustments in supply amount and temperature of coolant (e.g., water).

Pursuant to the present embodiment, the coolant pipe 19 spirally extends around the exterior of the piping passage 18, thereby forming the first temperature-regulating unit 12. Alternatively, the exterior of the piping passage 18 may be jacketed.

The exhaust gas containing the fullerenes and soot controlled to the predetermined temperatures by the first temperature-regulating unit 12 is supplied to the first filter 13. The first filter 13 is operable to separate solids from gases in the exhaust gas blown from the reactor 11, and has a heat-resistant filtering element 20 disposed within the first filter 13. The filtering element 20 desirably withstands higher temperatures, but is actually required to withstand temperatures of 600 to 900° C. in dependent upon the gas temperatures because the evaporated fullerenes and polycyclic aromatic compounds are allowed to permeate the filtering element 20 to collect the remaining soot (a carbonaceous high-molecular-weight constituent). The heat-resistant filtering element 20 is made of, e.g., a porous metal or a porous ceramics, but is preferably made of a sintered metallic material formed by any heat-resistant metal (e.g., stainless steel, Hastelloy, Inconel, chrome steel, and tungsten steel).

The first filter 13 is substantially identical in construction to a bag filter used in usual dust collectors. A heat medium heats a cylindrical casing 26 to keep the internal temperature of the casing 26 within a range of 600 to 700° C. A heat insulating material (not shown) extends around the exterior of the casing 26. This construction allows the fullerenes in the casing 26 to be kept in a vaporized state. Alternatively, the casing 26 may have a refractory disposed in the interior of the casing 26 and a heat-resistant metal disposed in the exterior of the casing 26. A heat medium can heat the heat-resistant metal from the outside up to a certain temperature (e.g., 100 to 400° C.). The exhaust gas from the reactor 11 can heat the internal surface of the refractory to any temperature of 600° C. or greater.

The first filter 13 uses the cylindrical filtering element 20 having the bottom thereon. The filtering element 20 is made of the refractory material as discussed above. The heat-resistant filtering element 20 as just discussed above can be, e.g., one sintered metal filter manufactured by the “Nippon Poll Inc.”, or another made by the “Fuji Filter Inc”. A filter opening size is, e.g., some 1 to some 5 μm, although may appropriately be selected in dependant upon combustion conditions for producing the fullerenes or soot properties.

A pulse jet mechanism 21 is disposed on the first filter 13 at the top thereof to periodically remove powdery solids (the soot) that are adhered to the first filter 13. The pulse jet mechanism 21 includes a tank 22 for storing a high-pressurized inert gas (e.g., nitrogen or argon), and an electromagnetic valve 23. The electromagnetic valve 23 is periodically opened in a short pulse to introduce the gas into the filtering element 20 from the tank 22, thereby allowing the solids adhered circumferentially on the filtering element 20 to fall down. As a result, the solids are discharged to the outside through an opened exhaust valve 24. When the gas ejected out of the pulse jet mechanism 21 is low in temperature, the ejected gas objectionably lowers the temperature of the filtering element 20. Accordingly, the filtering element 20 is desirably heated to temperatures ranging from at least 600° C. to at most 900° C. In this instance, the first temperature-regulating unit 12 may be provided with a pipeline operable to heat the filtering element 20 using the high-temperature exhaust gas that comes from the reactor 11.

A gas exit 25 is provided at an upper portion of the first filter 13, through which the gas having just permeated the filtering element 20 is discharged to the outside.

The second temperature-regulating unit 14 is provided at the gas exit 25 to span between the first filter 13 and the second filter 15. The second temperature-regulating unit 14 is substantially identical in construction to the first temperature-regulating unit 12, and includes a piping passage 30 and a coolant pipe 31 that extends around the exterior of the piping passage 30. The second temperature-regulating unit 14 lowers the temperature (in the range of greater than 600 to 900° C.) of the exhaust gas containing the fullerenes from the first filter 13 to a range of 300 to 600° C. (more preferably a range of 300 to 400° C.). As a result, the polycyclic aromatic compounds contained in the exhaust gas are retained in a gaseous state, while the fullerenes are solidified to form powder.

The gas flow in the piping passage 30 is desirably swirled. The swirled gas flow can minimize the adhesion of the fullerenes to the piping passage 30. A propeller-like, proper guide member may be provided at a gas entrance by way of means operable to swirl the gas flow in the piping passage 30 as well as feed the gas flow in a direction tangential to the peripheral surface of the piping passage 30.

The second filter 15 is substantially identical in construction to the first filter 13. The internal temperature of a casing 32 is maintained within a range of 300 to 400° C. The internal temperature is controlled to retain the polycyclic aromatic compounds in a gaseous state, but to form the fullerenes into powder. As a result, a sintered metallic filtering element 33, i.e., an example of the heat-resistant material, can collect the fullerenes. The cyclic aromatic compounds in the gaseous state permeate the filtering element 33, and then exit to the outside through a gas exit 34. An alternative filtering element may be formed by a porous metal or ceramics. The second filter 15 includes a pulse jet mechanism 21 that is identical in construction to that of the first filter 13. An exhaust valve 29 operable to discharge the collected fullerenes to the outside is provided on the second filter 15 at the bottom thereof.

The gases having just permeated the filtering element 33 are supplied to a gas-cooling apparatus 35 through the gas exit 34. The gas-cooling apparatus 35 is identical or similar in construction to a usual heat exchanger. The gas-cooling apparatus 35 cools the exhaust gas from the second filter 15 to temperatures of 200° C. or less (preferably temperatures in a range of 150° C. or less but equal or greater than an ordinary temperature). As a result, the polycyclic aromatic compounds and other hydrocarbon compounds are fluidized. These fluidized compounds are periodically discharged through a drain at a lower portion of the gas-cooling apparatus 35.

The gas-cooling apparatus 35 is followed by a decompressor 36 that is formed by a usual vacuum pump. A sublimation temperature of the fullerenes varies with a degree of vacuum. Accordingly, the decompressor 36 is controlled, in accordance with amounts of the supplied hydrocarbon fuel, oxygen, and inert gases, to provide a pressure sufficient to collect the fullerenes in the most efficient way.

Alternatively, an apparatus operable to collect the generated polycyclic aromatic compounds by lowering the temperature of the exhaust gas may be disposed at an entrance of the gas-cooling apparatus 35; the gas-cooling apparatus 35 may be used only to allow the gases led into the decompressor 36 to be cooled down to temperatures equal or less than the predetermined temperatures.

Pursuant to the present embodiment, the exhaust gas is reduced in temperature to the range of 300 to 600° C. before the exhaust gas is permitted to flow through the second filter 15. As a result, only the fullerenes are collected and solidified, while the polycyclic aromatic compounds are fed in the gaseous state through the second filter 15. Alternatively, the exhaust gas may be lowered in temperature to a range of 100 to 200° C. before the exhaust gas is permitted to permeate the second filter 15. As a result, the second filter 15 can capture the polycyclic aromatic compounds as well as the fullerenes. In the alternative, the filtering element of the second filter 15 can be made of a relatively inexpensive synthetic resin material; the second filter 15 need not be kept warm. As a result, the alternative as discussed above permits the second filter 15 to be manufactured at inexpensive costs. This alternative method is particularly advantageous when reaction conditions within the reactor 11 are established to yield a reduced amount of polycyclic aromatic compounds.

The following discusses how the fullerenes are produced using the above-described fullerene-manufacturing equipment 10.

First Process

A first process of the present invention provides a soot-containing gas flow that includes fullerenes. The fullerenes are provided in accordance with a combustion method in which a raw material (hydrocarbon fuel) is burned imperfectly in the reactor 11. Alternatively, in some cases, the fullerenes may be produced in accordance with a thermal decomposition method in which the hydrocarbon fuel is decomposed at high temperatures.

The production of the fullerenes concurrently results in carbonaceous high-molecular-weight constituents, i.e., the soot and a small amount of polycyclic aromatic compounds. Therefore, the gas flow or exhaust gas from the reactor 11 contains the fullerenes, soot, and polycyclic aromatic compounds.

The combustion method is suited for the mass production of the fullerenes. In addition, the maximum temperature at a fullerene-synthesizing region is some 2000° C., which is relatively lower than that according to other methods. Moreover, it is easy to determine a temperature zone where the fullerenes are present in a state of a vapor phase and where constituents other than the fullerenes, particularly the carbonaceous high-molecular-weight constituents occupying the majority of the soot, are present in a solid state. As a result, efficient separation of the fullerenes is achievable. Accordingly, the combustion method is preferred.

In general, the fullerenes are produced according to the combustion method under a pressure smaller than atmospheric pressure by way of a pressure condition. An appropriate selection can be made as to how much the pressure is reduced. More specifically, an emission volume from the decompressor 36 is regulated in such a manner that the reduced pressure falls within a range of, e.g., 20 to 200 torr (more preferably within a range of 30 to 50 torr).

Temperature conditions within the reactor 11 may properly be selected based on the pressure conditions as just discussed above. Preferred internal temperatures of the reactor 11 fall within a range of 1500 to 2000° C. Particularly preferred internal temperatures of the reactor 11 lie within a range of 1700 to 1900° C.

A preferred hydrocarbon fuel (a raw material of the fullerenes) can be aromatic hydrocarbons in which the number of carbons lies within a range of 6 to 20. The aromatic hydrocarbons include benzene, toluene, xylene, naphthalene, methylnaphthalene, anthracene, and phenanthrene. In conjunction with these aromatic hydrocarbons, aliphatic hydrocarbons such as hexane, heptane, and octane may be used as an alternative hydrocarbon fuel.

The hydrocarbon fuel used in the combustion method acts as a heat source as well. More specifically, the hydrocarbon fuel reacts with oxygen to generate heat, thereby raising a gas temperature to a degree sufficient to produce the fullerenes. At the same time, the hydrocarbon fuel is dehydrogenated, thereby producing carbon units to form a fullerene framework. The carbon units are collected together under certain pressure and temperature conditions, thereby forming the fullerenes.

An amount of oxygen used in the combustion method is somewhat varied according to types of hydrocarbon fuel. A molar ratio of carbon to oxygen (a molar ratio of a carbon amount in the hydrocarbon fuel to consumed oxygen) preferably falls within a range of 0.97 to 1.36, and more desirably within a range of 1.0 to 1.2.

In a reaction system in the combustion method, inert gases other than oxygen may be present in gases used to produce the fullerenes. In the present embodiment, the inert gases refer to gases substantially non-responsive to the fullerenes. The inert gases can be, e.g., argon or helium.

The soot-containing gas flow obtained according to the combustion method includes the fullerenes and the polycyclic aromatic compounds. The remaining soot other than the fullerenes and the polycyclic aromatic compounds includes the carbonaceous high-molecular-weight constituents such as high-molecular-weight hydrocarbons and carbon black. In these constituents, there are several hydrogen atoms, and a carbon graphite structure usually having a graphite structure is rendered as a skeleton.

The soot-containing gas flow obtained in the first process desirably contains 5 wt. % or greater of the fullerenes, more preferably 10 wt. % or greater, and particularly preferably 15 wt. % or greater. The fullerenes produced according to the present embodiment have the unlimited number of carbons as long as the fullerenes have fullerene structures. In general, the fullerenes have the number of carbons falling within a range of 60 to 84. In particular, it is preferred that C60 and C70 account for 50% or greater in the entire fullerenes.

Second Process

The gas flow containing the fullerenes and soot (the exhaust gas) provided by the first process usually has temperatures ranging from 1500 to 2000° C., and is too high in temperature to be fed through the first filter 13. The first temperature-regulating unit 12 lowers the temperature of the gas flow containing the fullerenes and soot (the exhaust gas) to a range of more than 600 to 900° C. At such predetermined temperatures, the fullerenes are held in a gaseous state. The cooled gas flow containing the fullerenes and soot (the exhaust gas) is allowed to flow through the first filter 13. As a result, the soot is collected from the exhaust gas. The rest of the exhaust gas is a gas that includes the fullerenes and a small amount of monocyclic or polycyclic aromatic compounds.

The soot collected by the first filter 13 contains a small amount of the fullerenes. The fullerene-containing soot is immersed into a solvent, thereby dissolving the fullerenes therefrom. In this instance, a small quantity of the solvent is required because a small amount of the fullerenes is contained in the soot. As a result, a considerably reduced amount of the solvent is totally used, when compared with that required in conventional methods. It was found from a chemical analysis of the fullerenes collected by the first filter 13 that polycyclic aromatic compounds equal or smaller than a detection value were present.

Third Process

The exhaust gas containing the fullerenes and the polycyclic aromatic compounds provided by the second process is further cooled down by the second temperature-regulating unit 14 to temperatures falling within a range of 300 to 600° C., and more desirably within a range of 350 to 450° C. As a result, the fullerenes are solidified to form powder, while the polycyclic aromatic compounds are held in a gaseous state. The second filter 15 collects the fullerenes from the cooled exhaust gas. The polycyclic aromatic compounds contained in the exhaust gas are allowed to flow through the second filter 15 as being in the gaseous state. When the polycyclic aromatic compounds enter the gas-cooling apparatus 35, the gas-cooling apparatus 35 cools down the polycyclic aromatic compounds, thereby fluidizing (sometimes partially solidifying) the polycyclic aromatic compounds. As a result, the fluidized (sometimes partially solidified) polycyclic aromatic compounds are collected. The exhaust gas having just flowed through the gas-cooling apparatus 35 is introduced by the decompressor 36, and is thereby discharged out of the equipment 10. Reference numeral 37 denotes a valve. Alternatively, the second filter 15 may be omitted, and the exhaust gas may be introduced directly from the first filter 13 into the gas-cooling apparatus 35. In this alternative, the fullerenes are precipitated in the gas-cooling apparatus 35.

As a further alternative, an apparatus as discussed below may be employed instead of the gas-cooling apparatus 35 to separate the polycyclic aromatic compounds from the exhaust gas before the exhaust gas is guided into the decompressor 36. The polycyclic aromatic compounds may be precipitated and then collected in accordance with any conventionally known art of collecting and fluidizing (or solidifying) gaseous substances. For example, gases containing the gaseous polycyclic aromatic compounds may be brought into contact with a cooled rotating drum to precipitate the polycyclic aromatic compounds; the precipitated aromatic compounds may be intermittently or continuously scraped from the rotating drum using a scraper, thereby collecting the scraped aromatic compounds. Alternatively, the polycyclic aromatic compounds adhered to the rotating drum may be dissolved using an organic solvent. As a result, the polycyclic aromatic compounds can be collected and removed from the drum.

Pursuant to the present embodiment, the exhaust gas supplied to the second filter has temperatures ranging from 300 to 600° C. When the exhaust gas contains a very small amount of the polycyclic aromatic compounds, the exhaust gas may be cooled down to temperatures of 200° C. or less, e.g., temperatures ranging from 150° C. to an ordinary temperature. As a result, the polycyclic aromatic compounds are fluidized as well. In this way, the fullerenes and the polycyclic aromatic compounds are all collectable from the second filter 15.

The present embodiment employs the inverted reactor 11 having the burner 16 and the exhaust port 17 formed at the upper and lower portions thereof, respectively. Alternatively, an upright reactor 42 may be used, as illustrated by a chain double-dashed line in FIG. 1. The upright reactor 42 has a burner 40 and an exhaust port 41 provided at lower and upper portions thereof, respectively.

### EMPIRICAL EXAMPLES

The following discusses experiments that were conducted to assure the operation and effects of the present invention.

### Experiment No. 1

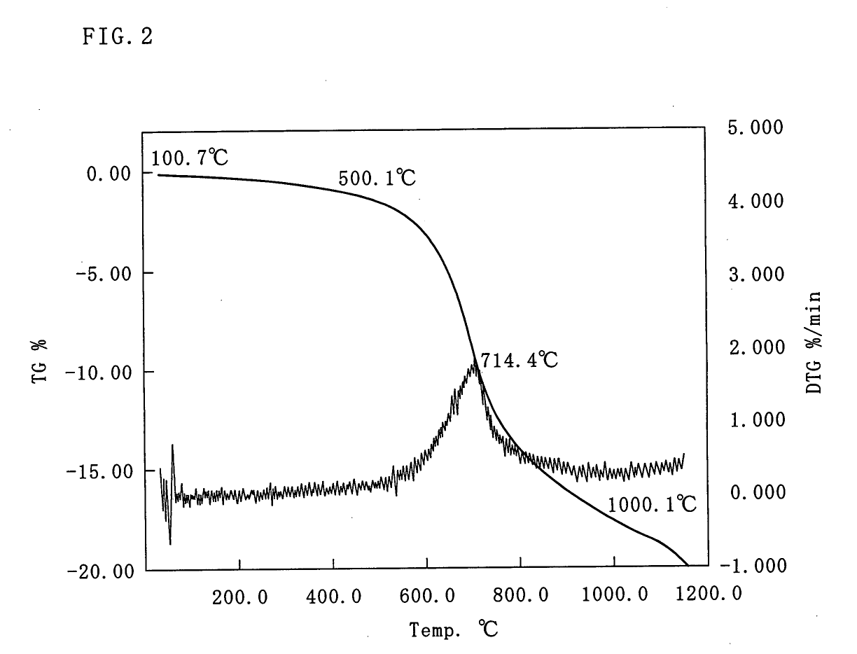

A thermogravimetric measuring apparatus (made by Seiko Inc., model TG-DTA6300) measured a change in weight of fullerene-containing soot in an amount of 3.8 mg. The fullerene-containing soot was produced in accordance with a combustion method using toluene (an example of a hydrocarbon fuel) as a raw material. To measure the weight change, the soot placed in a dry nitrogen gas of 100 cc per minute was heated up to 1150° C. from an indoor temperature. In this instance, the temperature was increased by 20° C. per minute. FIG. 2 shows results from the experiment. In FIG. 2, a leftward vertical axis, a rightward vertical axis, and a horizontal axis show a weight reduction ratio with reference to weight of 3.8 mg, a variation ratio of the weight reduction ratio, and heating temperatures, respectively. As evidenced by a weigh reduction-showing graph and a weight reduction ratio-showing graph in FIG. 2, it is found that the weight was reduced in steps when the temperature reached 100° C. or greater, and further that a reduction in weight accelerated at temperatures of nearly 400° C. In a high-temperature region of 600° C. or greater, the fullerene-containing soot was dramatically reduced in weight. Since the fullerenes are sublimated at temperatures ranging from 400 to 800° C., it is found that the sublimation of a large amount of the fullerenes in the soot sharply reduced the weight of the soot.

### Experiment No. 2

The following discusses experiment No. 2 that was conducted to assure the function and effects of the present invention. In the present experiment, the fullerene-manufacturing equipment 10 of FIG. 1 was employed, but the second filter 15 was omitted therefrom. In this instance, an exhaust gas ejected from the first filter 13 was allowed to flow directly into the gas-cooling apparatus 35. High-purity toluene was used as a hydrocarbon fuel. Flow rate regulators “A” and “B” were provided in a gaseous toluene-supplying passage and an oxygen-supplying passage, respectively, before the toluene and oxygen were supplied to the burner 16. In addition, a mixing chamber was provided for mixing the toluene and oxygen together after the toluene and oxygen flowed through the flow rate regulators “A” and “B”, respectively. As a result, the toluene and oxygen in predetermined amounts could be pre-supplied with a predetermined ratio to the burner 16.

The flow rate regulators “A” and “B” were regulated to provide a mixture gas adjusted in such a manner that an element composition ratio (a C/O molar ratio) of carbon in the toluene to oxygen consumed for the combustion of the toluene ranged from 0.97 to 1.36, and preferably from 1.0 to 1.2. The produced mixture gas was retained in an accumulated pressure chamber of the burner 16 to discharge the mixture gas into the reactor 11 through discharge ports (ejecting ports) of the burner 16 at speeds of, e.g., 70 to 300 cm per second. As a result, the mixture gas was stably fed into the reactor. The mixture gas-discharging speed was provided under the control over the internal pressure of the reactor 11 by regulating the ejecting pressure of the mixture gas and the emission volume of the decompressor 36.

While the decompressor 36 was operated to discharge gas from the interior of the reactor 11, the mixture gas was ejected into the reactor 11 through the discharge portion of the burner 16, thereby combusting the mixture gas. At this time, the emission volume of decompressor 36 was regulated to retain the interior of the reactor 11 under a reduced pressure ranging from, e.g., 20 torr to 200 torr, and preferably from 30 to 80 torr. The mixture gas was in a state in which the toluene and oxygen had fully been pre-mixed together before the mixture gas was supplied to the reactor. As a result, the toluene progressed to uniform combustion, thereby providing uniform- and high-temperatures (e.g., 1500 to 2000° C., and preferably 1700 to 1900° C.) of the interior of the reactor 11.

The C/O molar ratio and the reactor internal pressure were controlled within respectively predetermined ranges. Consequently, the formation of the soot was suppressed when unburned toluene was dissolved and heated. As a result, fullerene precursors were produced in large quantities. This feature provided an improved speed at which the fullerenes were formed, and consequently provided an improved yield of the fullerenes.

To further increase the temperature of the gas within the reactor 11, the mixture gas is desirably preheated before being ejected into the reactor 11. To achieve this, an electric heater or a heater using a heating medium, for example, may be wound around a pipe to heat the mixture gas when the mixture gas flows through the pipe. Such a preheating temperature can be equal or greater than a temperature at which the mixture gas is maintained in a gaseous state. The preheating temperature is desirably as high as possible to provide the improved yield of the fullerenes. However, to avoid explosions caused by spontaneous firing, the preheating temperature must be less than a temperature at which the hydrocarbon fuel or toluene is self-ignited.

Table 1 illustrates empirical examples No. 1 to No. 3 based on experiments carried out using the fullerene-manufacturing equipment 10.

As to temperatures at the entrance of the first filter 13 in examples No. 1 to No. 3, the temperature of the gas flow containing the fullerenes and soot (the exhaust gas) was controlled by control over the first temperature-regulating unit 12.

The amount of the fullerenes and that of the polycyclic aromatic compounds in the soot were measured in accordance with liquid chromatography and gas chromatography, respectively.

As evidenced by Table 1, when the exhaust gas supplied to the first filter 13 had a temperature of 570° C. (Example No. 1), it is found that only the fullerenes and soot were collected while the polycyclic aromatic compounds in the exhaust gas were evaporated to permeate the filtering element 20.

When the exhaust gas supplied to the first filter 13 had a temperature of 630° C. (Example No. 2), a reduced amount of fullerenes was trapped by the first filter 13 while an increased amount of fullerenes resides in the gas-cooling apparatus 35 that was preceded by the first filter 13. This means that the second filter 15 provided behind the first filter 13 can collect the fullerenes by cooling down the exhaust gas from the first filter 13.

In Example No. 3, the exhaust gas supplied to the first filter 13 had a temperature of 90° C.

TABLE 1

| | | Example 1 | Example 2 | Example 3 |
|---|---|---|---|---|
| Toluene flow rate | mol/hr | 68.7 | 171.75 | 68.7 |
| C/O molar ratio | | 1.15 | 1.15 | 1.15 |
| Reactor internal | torr | 40 | 40 | 40 |
| pressure | | | | |
| First filter entrance | ° C. | 570 | 630 | 90 |
| temperature | | | | |
| Produced soot amount | g/hr | 200 | 500 | 230 |
| Polycyclic aromatic | ppm | 57.6 | Measurement | 348.6 |
| compounds in soot | | | limited (50 | |
| | | | ppm) or less | |
| Fullerenes in soot | % | 21 | 14.5 | 20 |
| trapped by | | | | |
| first filter | | | | |
| Fullerenes in soot | % | Unknown | 98.5 | N/A |
| collected by | | | | |
| gas-cooling apparatus | | | | |

1. A method for producing fullerenes, comprising:
a first process of imperfectly combusting or thermally decomposing a hydrocarbon fuel in a reactor, thereby producing a high-temperature gas flow containing fullerenes and soot;
a second process of introducing the high-temperature gas flow containing the fullerenes and the soot from said reactor into a first filter including a heat-resistant filtering element, to allow the fullerenes in a gaseous state to flow through said first filter, thereby collecting the soot from the gas flow in said first filter; and
a third process of lowering a temperature of the gas flow having just flowed through said first filter, in order to solidify the fullerenes, thereby collecting and separating the fullerenes from the gas flow.

2. A method for producing fullerenes as defined in claim 1, wherein the high-temperature gas flow containing the fullerenes and the soot at an entrance of said first filter has a temperature falling within a range of more than 600 to 900° C.

3. A method for producing fullerenes as defined in claim 2, wherein the gas flow after having flowed through said first filter has a temperature controlled within a range at which polycyclic aromatic compounds contained in the gas flow are held in a gaseous state; and
wherein the fullerenes free of the polycyclic aromatic compounds are collected using a second filter.

4. A method for producing fullerenes as defined in claim 3, wherein the controlled temperature of the gas flow ranges from 300 to 600° C.

5. A method for producing fullerenes as defined in claim 2, wherein the gas flow after having flowed through said first filter is cooled down to a temperature of 200° C. or less, thereby collecting the solidified fullerenes from the gas flow using a second filter.

6. A method for producing fullerenes as defined in claim 1, wherein said reactor is provided with an exhaust port at a lower portion of said reactor, through which the high-temperature gas flow containing the fullerenes and the soot is discharged to outside of said reactor.

7. A method for producing fullerenes as defined in claim 6, wherein said reactor is provided with a burner at an upper portion of said reactor for imperfectly combusting or thermally decomposing the hydrocarbon fuel.
